(19) United States
(12) Patent Application Publication
(10) Pub. No.: US 2014/0167413 A1
(43) Pub. Date: Jun. 19, 2014

(54) FISHING AID

(71) Applicant: Oliver Ross, Hillington (GB)

(72) Inventor: Oliver Ross, Hillington (GB)

(73) Assignee: M2H INDUSTRIES LIMITED, Hillington (GB)

(21) Appl. No.: 14/111,407

(22) PCT Filed: Apr. 12, 2012
(86) PCT No.: PCT/GB12/50794

§ 371 Date: Jan. 28, 2014

(30) Foreign Application Priority Data
Apr. 15, 2011 (GB) 1106431.8

(51) Int. Cl. A01K 91/04; B65H 69/04; A01K 97/00

(52) U.S. Cl. CPC A01K 91/04; A01K 97/00; B65H 69/04
USPC 289/1.5; 289/17

(57) ABSTRACT

There is herein described a fishing aid. More particularly, there is described a fishing aid capable of tying knots in fishing lines to connect the fishing line to hooks, flies and/or lures.

### FIELD OF THE INVENTION

The present invention relates to a fishing aid. More particularly, the present invention relates to a fishing aid capable of tying knots in fishing lines to connect fishing line to hooks, flies and/or lures.

### BACKGROUND OF THE INVENTION

Recreational and sport fishing is one of the most popular activities worldwide. In the US alone there are 40 million anglers generating $45 Billion in retail sales. Many anglers have problems tying the knots needed to attach their line to their hook's/flies and lures. This is due to a number of different reasons such as bad dexterity, poor eyesight, cold weather, windy conditions, dark nights and so on. Also many anglers are never taught the knots properly and subsequently don't tie the right knots, which means that their line can break easily. The most common and trusted knot for this connection is called the clinch knot/half tucked blood knot. This is the knot that the fishing aid of the present invention specifically ties.

There are three main problems encountered by anglers having to tie knots to secure their hooks:

1. Threading the fishing line through the small holes on the hook.

2. Forming the complex knot.

3. Tightening the knot.

It is an object of at least one aspect of the present invention to obviate or mitigate at least one or more of the aforementioned problems.

It is a further object of at least one aspect of the present invention to provide a fishing aid capable of facilitating the process of tying knots to fishing lines to attach hooks, flies and/or lures.

It is a further object of at least one aspect of the present invention to provide a method of facilitating the process of tying knots to fishing lines to attach hooks, flies and/or lures.

### SUMMARY OF THE INVENTION

According to a first aspect of the present invention there is provided a fishing aid comprising:

an elongate body having a front and rear end;

the front end of the elongate body having an opening and a channel capable of receiving a fishing line;

the front end of the elongate body also comprising a slot through which part of a hook is capable of being slid;

on an outer surface of the elongate body there is a first and second funnel through which the fishing line is capable of being inserted and wherein the channel at the front end of the elongate body extends through to both the first and second funnels; and

wherein the fishing aid is capable of allowing anglers to tie knots and attach hooks, fishing flies and/or lures.

The present invention therefore relates to a fishing aid which allows anglers to tie knots and attach hooks, fishing flies and/or lures in seconds.

Typically, the slot at the front of the elongate body allows for self alignment of the hook, fly and/or lure. For example, an eye on the hook may be self-aligned and at substantially right angles with the channel at the front end of the elongate body allowing the fishing line to be easily inserted there through. This allows the fishing line to be fed straight through the eye of the hook/fly/lure.

The fishing aid allows the hook, fly and/or lure to be held in place as the fishing line is fed down through the first funnel and through the channel at the front end of the elongate body. The hook, fly and/or lure may be positioned and/or centered by a user to ensure that the eye of the hook is directly in front of the channel at the front end of the elongate body and at substantially right angles. To facilitate this process a hollow cylindrical insert may be used and inserted into the front end of the cylindrical body. The hollow cylindrical insert and part of the elongate body may comprise a slot through which a hook, fly and/or lure may be slid down and centered. The insert may take the form of, but not limited to: a funnel (e.g. made from rubber); a clamp; adhesive or a retaining wall.

In alternative embodiments, a separate tool or a “dual tool” may be used for larger holed lures. The attachment or “dual tool” allows a protruding end piece to allow the lure to be slotted onto it.

On the outer surface of the elongate body there may be grooves and/or visual means to instruct and/or direct the user to form a knot. For example, the user may loop once leaving a gap and then loop a further, for example, 4 times to form a clinch knot. In particular embodiments, the fishing line may be wrapped between the grooves on the outer surface of the elongate body to forma knot with a space made between the 1^{st} and 2^{nd} turns of the line to allow the line to be passed back through. The second funnel allows the fishing line to be passed under the first loop of fishing line. Then pulling spare line and the hook with one hand, while the other hand holds the fishing aid, the fishing line may be tightened to tie the knot. The fishing aid also allows the fishing line to slip easily off the elongate body of the fishing aid leaving the completed knot.

A further advantage of the fishing aid according to the present invention is that due to the fishing line being tunneled out close to the hook/fly/lure it allows the user to hold both items and pull them away from the tool, which tightens the knot.

In an alternative embodiment, the invention may be performed by having a flexible wall that allows a large gap to be formed between the turns of the line, allowing a large space for the line to be passed back through. When it becomes time for the hook and line to be pulled off the tool the flexible wall collapses.

According to a second aspect of the present invention there is provided a method of using a fishing aid to tie a fishing line to a hook, fly and/or lure comprising:

providing an elongate body having a front and rear end;

providing the front end of the elongate body having an opening and a channel capable of receiving a fishing line;

providing the front end of the elongate body also comprising a slot through which part of a hook is capable of being slid;

on an outer surface of the elongate body there is a first and second funnel through which the fishing line is capable of being inserted and wherein the channel at the front end of the elongate body extends through to both the first and second funnels; and

wherein the fishing aid is capable of allowing anglers to tie knots and attach hooks, fishing flies and/or lures.

The fishing aid may be as defined in the first aspect.

### BRIEF DESCRIPTION OF THE DRAWINGS

Embodiments of the present invention will now be described, by way of example only, with reference to the accompanying drawings in which:

FIG. 1 is a side view of a fishing aid according to an embodiment of the present invention showing a hook ready to be attached;

FIG. 2 is a view of the fishing aid shown in FIG. 1 with the hook attached;

FIG. 3 is an exploded view of the fishing aid shown in FIGS. 1 and 2; FIG. 4 is an expanded view of an insert capable of being inserted into an end of the fishing aid and a hook;

FIG. 5 is a view of the insert and hook shown in FIG. 4 attached to one another;

FIGS. 6 to 9 are further views of the fishing aid;

FIGS. 10 to 11 are views of the fishing aid getting ready to be used with a fishing line;

FIG. 12 is a further view of the fishing aid shown in FIGS. 9 to 11 showing an insert and a hook;

FIGS. 13a to 13i show the method of attaching a hook to a fishing line using the fishing aid shown in FIGS. 1 to 12; and

FIGS. 14a to 14g show a further fishing aid according to the present invention.

### BRIEF DESCRIPTION

Generally speaking, the present invention resides in the provision of a fishing aid capable of tying knots in fishing lines to connect the fishing line to hooks, flies and/or lures. The fishing aid is a handheld device which assists anglers in tying knots in fishing lines to all types of hooks, flies, lures and the like. The fishing aid specifically helps with threading the fishing line through the holes of the hooks, flies and lures, as well as forming the knot, and the tightening of the knot. The fishing aid also comprises a blade (e.g. a line cutter) that cuts through all types of fishing line with ease.

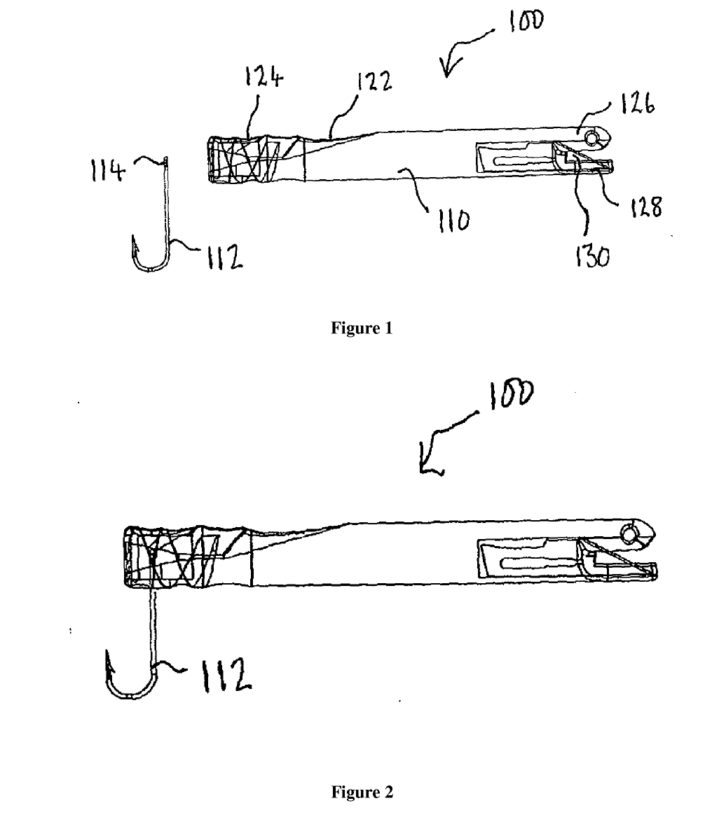

FIG. 1 is a view of a fishing aid according to the present invention generally designated 100. The fishing aid 100 comprises a main cylindrical body 110. At the frond end of the fishing aid 100 there is a first funnel 122 and a second funnel 124. (The first funnel 122 is usually larger than the second funnel 124). There is also shown a hook 112 which has an eye 114 ready to be threaded onto a fishing line. At the rear end of the fishing aid 100 there are two protruding members 126, 128 and located between them a blade 130 capable of cutting fishing line.

FIG. 2 shows the fishing aid 100 attached to the hook 112. This process will be described in more detail below.

FIG. 3 shows the fishing aid 100 ready to be attached to an insert 116 and the hook 1 14.

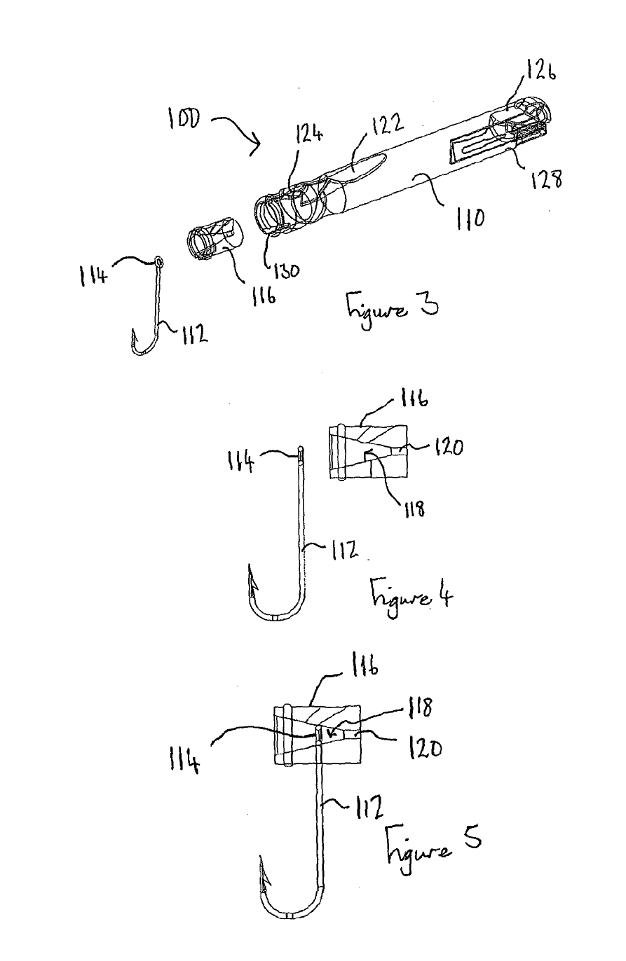

FIG. 4 is an expanded view of the insert 1 16 and the hook 114. As shown in the cross-sectional view of the insert 1 16 there is a central conically shaped section 118 which is capable of receiving the top end of the hook 112 with the eye 114. At the end of the conical section 118 there is a channel 120 along which the fishing line may be fed. This is described in more detail below. FIG. 5 shows the hook 112 inserted into the insert 116 whereupon the hook 1 18 has been slid along a slot 130 in the bottom of the insert 116 and fishing aid 100.

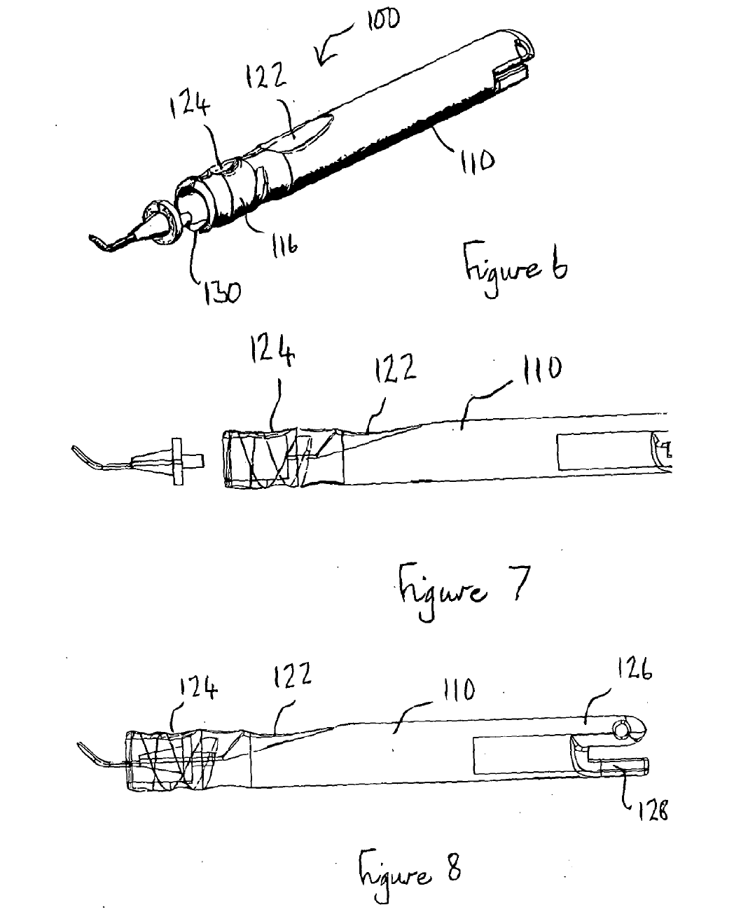

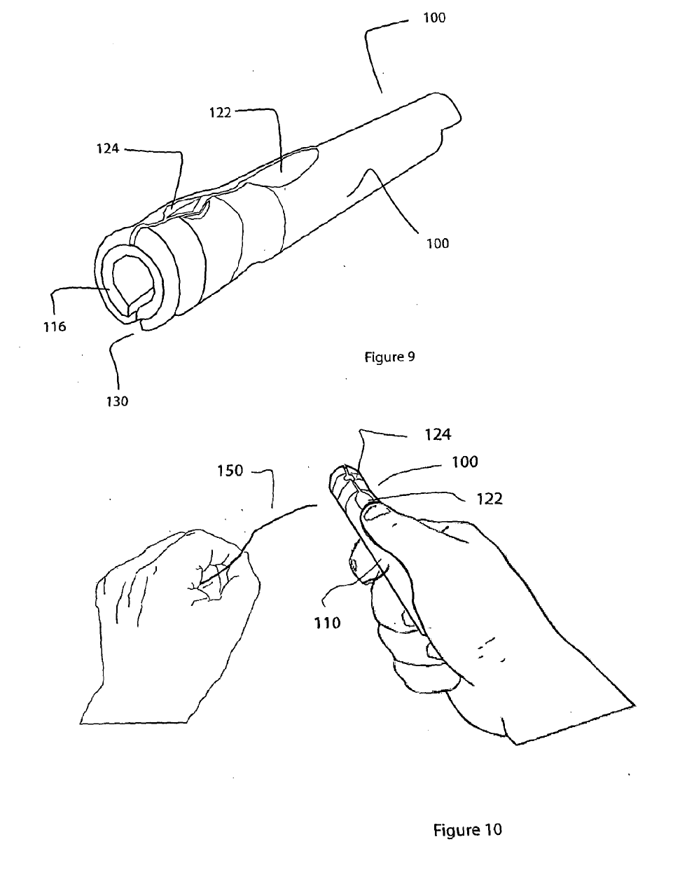

FIGS. 6 to 9 are further views of the fishing aid 100 and shows that at the bottom of the insert 116 there is a slot 130 capable of receiving the hook 112.

FIG. 10 shows a fishing line 150 being brought up to the fishing aid 100. The insertion of the fishing line and the tying of the knot will be described below.

FIG. 11 shows the fishing line 150 extending through the fishing aid 100.

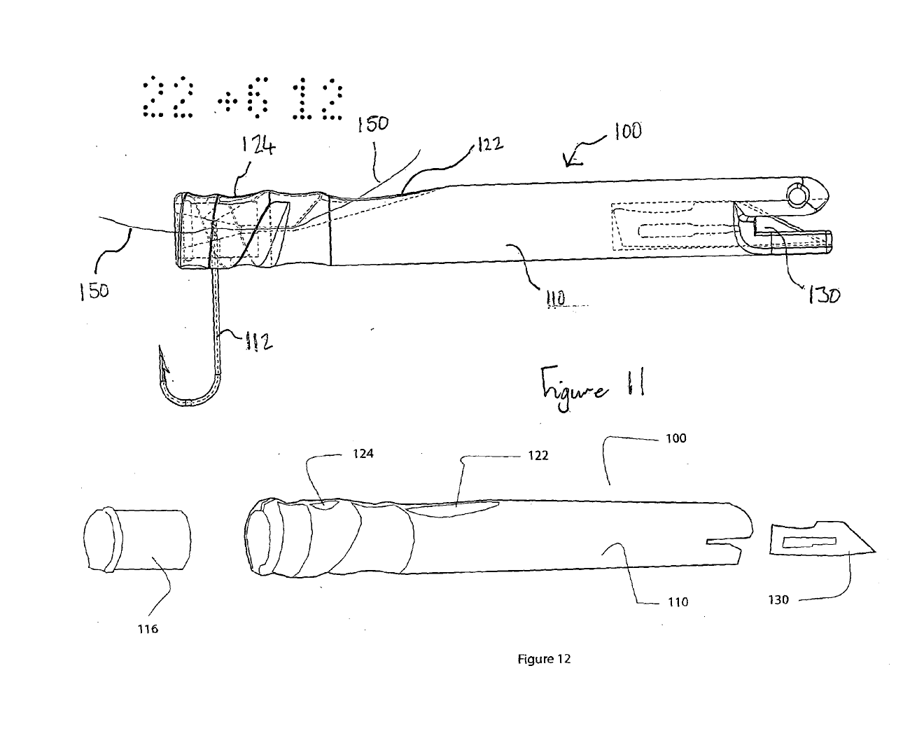

FIG. 12 is a further view of the fishing aid 100 showing the insert 116 ready to be inserted and the blade 130.

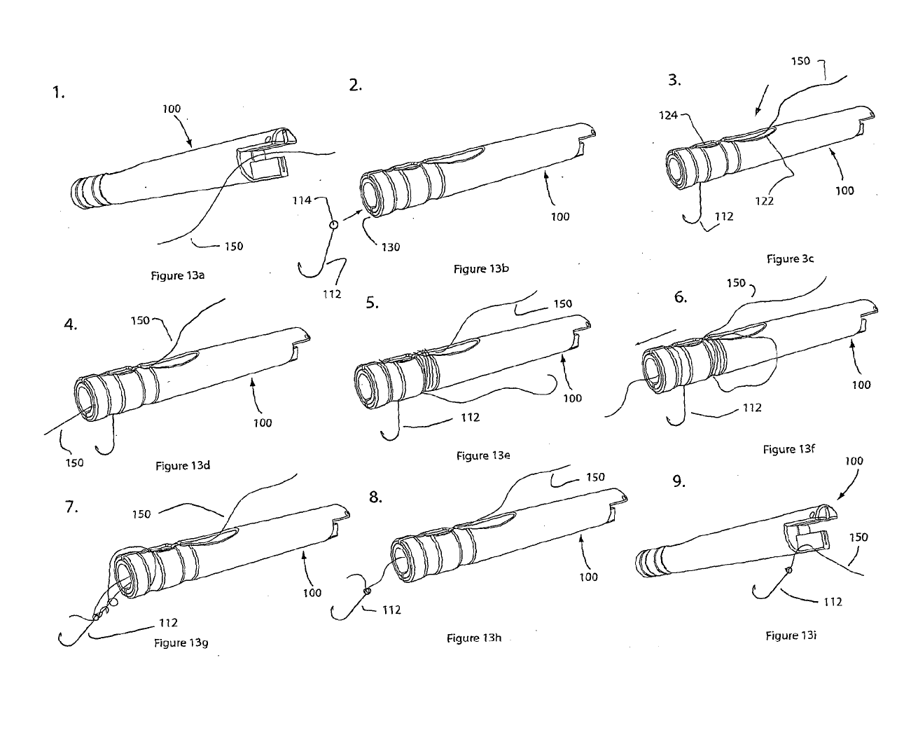

FIGS. 13a to 13g show the method of tying a knot with the fishing aid 110:

FIG. 13a shows the cutting of the fishing line 150 so that there is a clean piece of line ready to be used with the fishing aid 100;

FIG. 13b shows the hook 1 12 (and/or a fly or lure) in front of the fishing aid 100 until it aligns itself and is held in place. The hole 114 of the hook

1 12 is aligned so that is at right angles or substantially at right angles with front of the fishing aid 100 and in line with the first funnel 122;

FIG. 13c shows the fishing aid 100 as shown in FIG. 13b and the fishing line 150 inserted into the first funnel 122 so that the line 50 comes out of the front of the fishing aid 100. In use, a user then places a thumb loosely on top of the first funnel 122 holding the line 150;

FIG. 13d then shows to pull roughly 30 cm (a ruler's) worth of line out of the fishing aid 100. Once this has been done a user then presses down on the line 150 with a thumb on top of the funnel 122;

FIG. 13e shows that following a coloured path on the fishing aid 100 the line 150 is wrapped once around the first loop and 4 times around the larger loop. Once this has been done a finger is placed on top of some or all of the line 150 on the large part of the path;

FIG. 13f shows then to insert line 150 into the smaller funnel 124 until it comes out of the front of the fishing aid 100;

FIG. 13g then shows that a user grasps the hook, fly or lure and the free line 150 with their free hand and pulls them away from the fishing aid 100, whilst pressing down on the line 150 with their thumb using their other hand. (A user may need to “wiggle the tool slightly);

FIG. 13h shows then to pull line 150 out of the top of the fishing aid 100 and tighten the knot as far as it will go; and

FIG. 13i shows finally to cut excess line from knot.

In use, the angler therefore simply places the hook/fly/lure into the end insert 1 16 which by design is self aligning allowing it to hold the hook/fly/lure central to the line funnel (aligning the eye of the hook/fly/lure to the line funnel). The fishing line 150 is then passed down the first funnel 122, from the top of the fishing aid 100, self threading the eye 1 14 of the hook/fly/lure and passing out from the insert 1 16. The angler then allows around 30 cm of the line 150 to pass through before taking the line 150 and forming the knot around the fishing aid 100. The outer casing of the fishing aid 100 has groove details (or a visual helical path) to show the angler how the knot should be formed. There is one grove at the front followed by 4 groves at the rear, these grooves are separated from the 1^{st} to 2^{nd} turn allowing for a gap in which to pass the line through after the knot has been formed over the 5^{th} groove. Once the knots have been formed the angler takes the end of the line and passes it between the 1^{st} and 2^{nd} turn down the second funnel 124, the end of the line 150 comes out the second funnel 124 at the front of the hook/lure insert 1 16 allowing the angler to grip the end of the line 150 with the hook 1 12 and pull both out in a parallel direction to the barrel of the fishing aid 100. The grooves are formed in a way to allow the knot to easily slip off the fishing aid 100 and tighten when pulled. A concealed blade 130 is in the rear of the fishing aid 100 allows the angler to cut the excess of the line once the knot forming is complete.

The fishing aid 100 has a number of technical advantageous features:

1. The fishing aid 100 provides a novel end piece inset 1 16 that allows any size of hook and fly to be held in place.

2. The fishing aid 100 also provides another end piece insert that allows larger lures to be held in place. This end piece can also be encompassed in one tool. The inserts will be designed to accommodate all sizes of hook/fly/lure(s).

3. When slotting the hook/fly/lure into the fishing aid 100 it self-aligns itself into a position that is in line with the channel of the fishing line 150.

4. The fishing aid 100 has a large funnel 122 on the top that allows the user to thread the fishing line 150 into it with ease; this in turn goes straight through the aligned hook/fly/lure.

5. The body of the fishing aid 100 allows the user to form the turns of the knot easily and provides a space between the 1^{st} and 2^{nd} turns.

6. There is a second funnel 124 on the fishing aid 100 that allows the user to thread the line 150 back through between the 1^{st} and 2^{nd} turn of the line 150.

7. The line 150 comes out of the 2^{nd} funnel 124 next to the hook 1 12 and the user can then pull the hook 1 12 and end piece of the line 150 away from the fishing aid 100 that tightens the knot.

8. Having tightened the knot, the line 150 can be pulled out of the fishing aid 100 with ease.

9. The line cutter 130 can then be used to cut the spare line away from the knot.

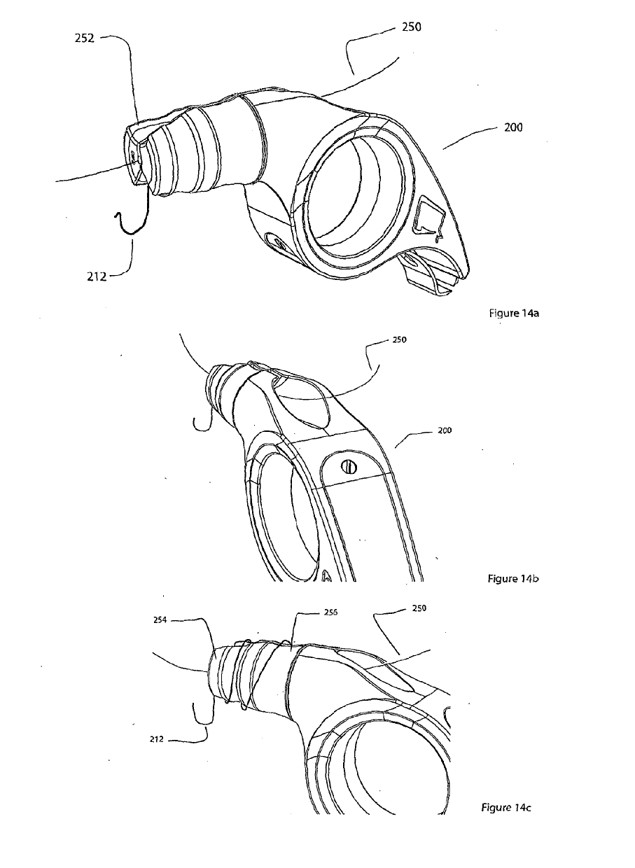

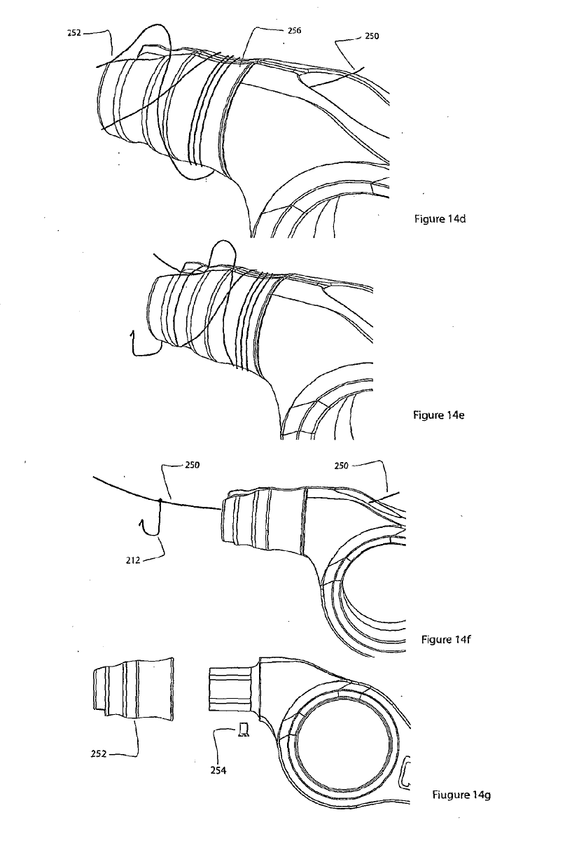

FIG. 14a is a representation of a fishing aid 200 according to a further embodiment of the present invention. In FIG. 14a the hook 212 is placed in the head 252 of the fishing aid 200. In FIG. 14b the line 250 is fed through a channel and in FIG. 14c the line 250 is wound once around a first ring 254. In FIG. 14d the line 250 is wound three times around a second ring 256. In FIG. 14e the guide line is then fed back through the opening in the first loop. Then as shown in FIG. 14f the line and hook is pulled out together to complete the knot. FIG. 14g shows that the hook head 252 can be replaced by unscrewing a screw 254 to detach the head 252. This allows a variety of heads to be used which allows a range of hooks to be used in the present invention.

Whilst specific embodiments of the present invention have been described above, it will be appreciated that departures from the described embodiments may still fall within the scope of the present invention. For example, any suitable type of funnels may be used to feed the fishing line into the central region of the fishing aid. In addition, any number of grooves may be used to assist in the tying of knots.

1. A fishing aid comprising:
an elongate body having a front and rear end;
the front end of the elongate body having an opening and a channel capable of receiving a fishing line;
the front end of the elongate body also comprising a slot through which part of a hook is capable of being slid;
on an outer surface of the elongate body there is a first and second funnel through which the fishing line is capable of being inserted and wherein the channel at the front end of the elongate body extends through to both the first and second funnels; and
wherein the fishing aid is capable of allowing anglers to tie knots and attach hooks, fishing flies and/or lures.

2. A fishing aid according to claim 1, wherein the slot at the front of the elongate body allows for self alignment of the hook, fly and/or lure.

3. A fishing aid according to claim 1, wherein an eye on the hook is capable of being self-aligned at substantially right angles with the channel at the front end of the elongate body allowing the fishing line to be easily inserted there through and the fishing line to be fed straight through the eye of the hook/fly/lure.

4. A fishing aid according to claim 1, wherein the fishing aid therefore allows the hook, fly and/or lure to be held in place as the fishing line is fed down through the first funnel and through the channel at the front end of the elongate body.

5. A fishing aid according to claim 1, wherein the hook, fly and/or lure are capable of being positioned and/or centered by a user to ensure that the eye of the hook is directly in front of the channel at the front end of the elongate body and at substantially right angles.

6. A fishing aid according to claim 5, wherein to facilitate the positioning and/or centering of the hook, fly and/or lure a hollow cylindrical insert is used and inserted into the front end of the cylindrical body.

7. A fishing aid according to claim 6, wherein the hollow cylindrical insert and part of the elongate body comprises a slot through which a hook, fly and/or lure are capable of being slid down and centered.

8. A fishing aid according to claim 6, wherein the insert takes the form of: a funnel (e.g. made from rubber); a clamp; adhesive or a retaining wall.

9. A fishing aid according to claim 1, wherein on the outer surface of the elongate body there are grooves and/or visual means to instruct and/or direct the user to form the knot.

10. A fishing aid according to claim 1, wherein the user loops once leaving a gap and then loops a further 4 times to form a blood knot.

11. A fishing aid according to claim 1, wherein the fishing line is wrapped between grooves on the outer surface of the elongate body to form the knot with a space made between the 1^{st} and 2^{nd} turns of the line to allow the line to be passed back through.

12. A fishing aid according to claim 1, wherein the second funnel allows the fishing line to be passed under the first loop of fishing line and then pulling spare line and the hook with one hand, while the other hand holds the fishing aid the fishing line are capable of being tightened to tie the knot.

13. A fishing aid according to claim 1, wherein the fishing aid also allows the fishing line to slip easily off the elongate body of the fishing aid leaving the completed knot.

14. A method of using a fishing aid to tie a fishing line to a hook, fly and/or lure comprising:
providing an elongate body having a front and rear end;
providing the front end of the elongate body having an opening and a channel capable of receiving a fishing line;
providing the front end of the elongate body also comprising a slot through which part of a hook is capable of being slid;
on an outer surface of the elongate body there is a first and second funnel through which the fishing line is capable of being inserted and wherein the channel at the front end of the elongate body extends through to both the first and second funnels; and
wherein the fishing aid is capable of allowing anglers to tie knots and attach hooks, fishing flies and/or lures.
